(19) United States
(12) Patent Application Publication
(10) Pub. No.: US 2007/0033602 A1
(43) Pub. Date: Feb. 8, 2007

(54) Disk Unit

(75) Inventors: Yota Hashimoto, Fukuoka (JP); Yoshihiro Kiyomura, Fukuoka (JP); Junya Aso, Fukuoka (JP); Seiro Shimoda, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/495,622

(22) Filed: Jul. 31, 2006

(30) Foreign Application Priority Data
Aug. 3, 2005 (JP) 2005-224885
Dec. 5, 2005 (JP) 2005-350371

(51) Int. Cl. G11B 7/00

(52) U.S. Cl. 720/671

(57) ABSTRACT

In the case of a disk with a high NA which enables high-density recording, since the coma aberration increases as the numerical aperture, NA, increases, a disk protective layer needs to be thin very much, and a damage or scratch imparted to a surface of the disk affects largely the record and reproduction of data. An object of the invention is to reduce the generation of damage to a storage disk due to a collision between a lens holder or an objective lens and the storage disk. With a view to attaining the object, according to the invention, a longitudinal direction of a protector 11 provided on a holder is made substantially parallel to a straight line which connects the rotational center of a motor with the center of an objective member.

### BACKGROUND OF THE INVENTION

1. Field of the Invention

The present invention relates to a storage disk unit which plays back or implements recording on a storage disk and more particularly to a disk unit having a protector which is formed at a location which is or is likely to be brought into contact with a storage disk for preventing a damage thereto.

2. Description of the Related Art

In recent years, in association with development in digital technologies, there has been a demand for high-density storage disks such as optical disks, hard disks and MO's. Due to this, once a scratch is imparted to such a storage disk, there will be caused a damage of far more digital data than digital data that would be damaged when a scratch is imparted to a conventional storage disk, and hence, there has been a demand for countermeasures thereagainst.

In particular, in the area of optical disks, there have been developed various types of optical disks. In portable personal computers which can be carried and so-called note-type personal computers, it is assumed that an impact is applied to an optical disk unit accidentally while playing back or implementing recording on a CD or DVD, leading to a concern that a lens holder or an objective lens is then brought into collision with a surface of the optical disk to thereby damage the surface. In addition, in an optical disk unit having a function to gather light with the same lens for CD and DVD, there occurs a problem that an objective lens collides against an optical disk due to a difference in working distance therebetween, and this may result in a case where the objective lens and/or a recordable surface of the optical disk is damaged.

Furthermore, in recent years, in order to realize such high-density optical disks, objective lenses of a high numerical aperture or NA are used for pickups, and short-wavelength laser light sources are used as light sources. When the numerical aperture of an objective lens is increased, a space (a working distance W) between the objective lens and the optical disk is inevitably narrowed as long as the diameter of the lens is not increased. As this occurs, an interval between the objective lens and the optical disk gets narrowed very much. Due to this, there occurs a collision between the objective lens and the optical disk due to the degree of precision of the optical disk itself and the deflection of the optical disk in operation, and there is caused a higher possibility that a damage is made onto the objective lens and/or the recordable surface of the optical disk.

To deal with the problem that the objective lens and the recordable surface of the optical disk of such an optical disk unit are damaged, an objective lens collision preventive protector portion is provided on the periphery of the objective lens in such a manner as to protrude further towards the optical disk than the objective lens. By providing such an objective lens collision preventive protector portion, even in the event that there occurs an abnormal approach between the objective lens and a disk protective layer, since the objective lens collision preventive protector comes into contact with the disk protective layer earlier than the objective lens, a damage to the objective lens can be prevented. In addition, by using resin or the like as the objective lens collision preventive protector portion, even in the event that the objective lens collision preventive protector portion comes into collision with the disk preventive layer, a damage to the surface of the disk protective layer can be prevented.

As the objective lens collision preventive protector portion, there are disclosed techniques in which a closest portion to an optical disk is formed of a material which is softer than the optical disk (refer to, for example, JP-A-2-54433), a silicone rubber is mounted on the periphery of an objective lens (refer to, for example, JP-A-11-312322), a cushion material of wool felt or the like is mounted on the periphery of an objective lens (refer to, for example, Japanese Patent No. 2593998), and an elastic element such as rubber is mounted on an objective lens itself (refer to, for example, JP-A-2000-242958).

Even an objective lens collision preventive protector portion like the one disclosed in the aforesaid patent documents Nos. 1 to 4 can be considered to fulfill its function sufficiently for a disk having a relatively thick disk protective layer as of the conventional CD or DVD. In the case of the disk with the high NA which enables high-density recording, however, since the coma aberration increases as the numerical aperture increases, the disk protective layer needs to be thin very much. The fact that the disk protective layer is thin means that a damage or scratch imparted to the surface of the disk affects the record and reproduction of data more than before, and hence, there is a demand for countermeasures thereagainst.

An object of the invention is to reduce the generation of a damage to a storage disk resulting from the collision between the lens holder or the objective lens and the storage disk.

A longitudinal direction of a protector provided on a holder is made substantially parallel to a straight line which connects the rotational center of a motor with the center of an objective member.

According to a disk unit of an embodiment of the invention, it is possible to reduce the occurrence of a damage to a storage disk due to a collision between a protector and the storage disk.

### BRIEF DESCRIPTION OF THE DRAWINGS

FIG. 1 is an exemplary diagram of an embodiment of the invention.

FIG. 2 is an exemplary diagram showing a comparison example to the embodiment of the invention.

FIG. 3 are exemplary diagrams showing possible cross sections according to the embodiment of the invention.

FIG. 4 is a graph showing cross sectional shapes of the embodiment of the invention and a comparison example.

FIG. 5 are exemplary diagrams showing the embodiment of the invention and the comparison example.

FIG. 6 is an exemplary diagram showing a direction in which fragments are thrown which are generated due to a collision between a storage disk and a protector.

FIG. 7 is an exemplary diagram of the embodiment of the invention.

FIG. 8 are exemplary diagrams showing possible cross sections according to the embodiment of the invention.

FIG. 9 are exemplary diagrams of the embodiment of the invention.

FIG. 10 are exemplary diagrams showing possible cross sections according to the embodiment of the invention.

FIG. 11 is a diagram showing the whole of experimental equipment according to the embodiment of the invention.

FIG. 12 is an exemplary diagram showing a section of the whole of the experimental equipment according to the embodiment of the invention.

FIG. 13 is a diagram showing an optical disk unit according to the embodiment of the invention.

FIG. 14 is a diagram showing part of the optical disk unit according to the embodiment of the invention.

FIG. 15 is a diagram showing part of an optical pickup unit according to the embodiment of the invention.

FIG. 16 is a graph showing the results of a test carried out according to the embodiment of the invention.

FIG. 17 is a graph showing the results of a test carried out according to the embodiment of the invention.

FIG. 18 is a diagram showing the contents of the test carried out according to the embodiment of the invention.

FIG. 19 is a graph showing the results of a test carried out according to the embodiment of the invention.

FIG. 20 is a diagram showing a test method according the embodiment of the invention.

### DESCRIPTION OF THE PREFERRED EMBODIMENTS

Hereinafter, an embodiment of the invention will be descried in detail using the accompanying drawings. Note that dimensions given on the drawings are such as to facilitate the understanding of the invention and are different from actual dimensions.

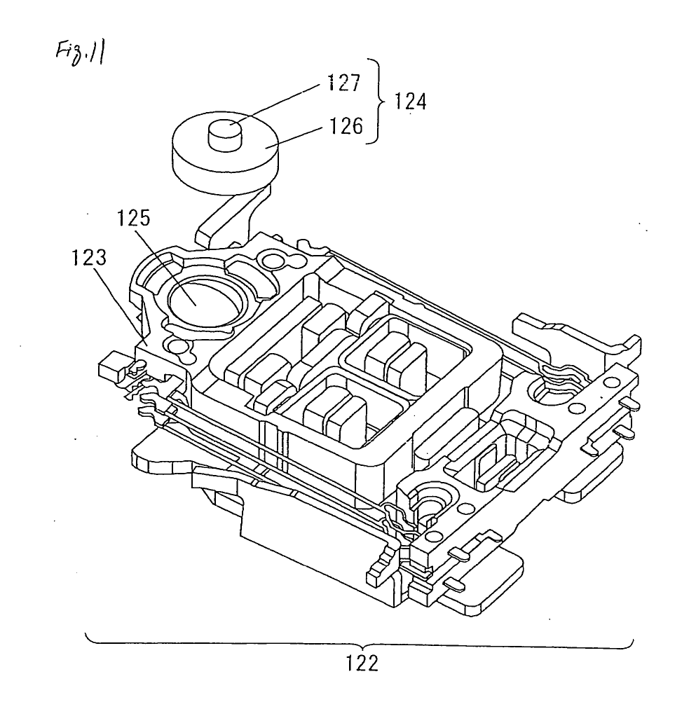

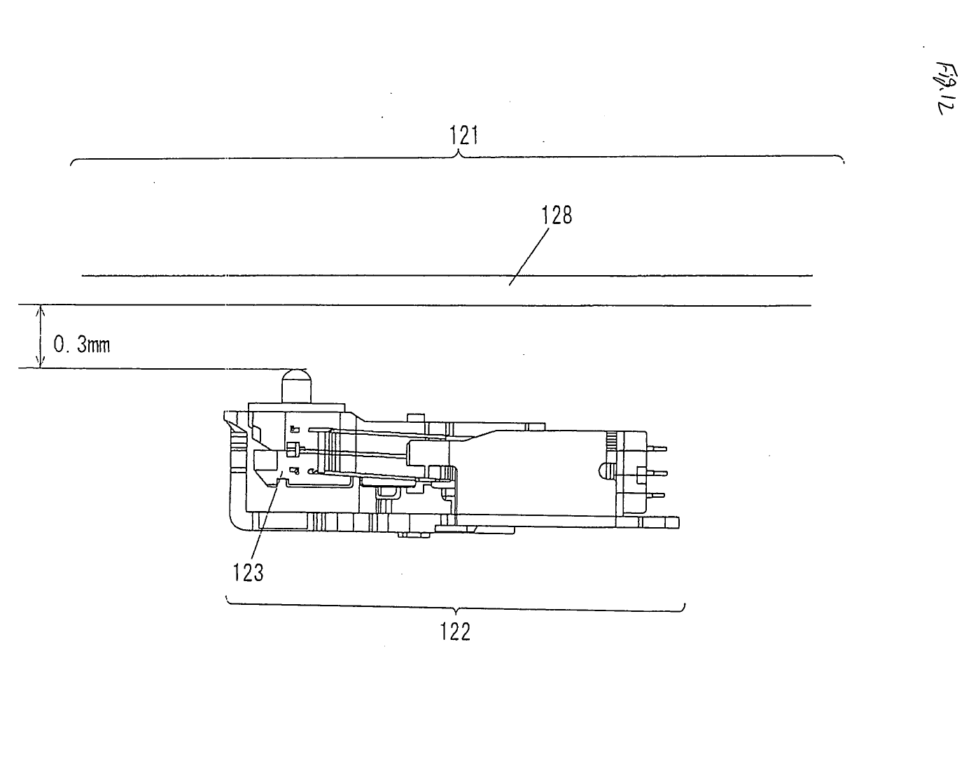

FIG. 11 is a perspective view of an objective lens holder of experimental equipment for obtaining the depth of a damage mark given onto an optical disk through a collision test, and FIG. 12 is a sectional exemplary diagram showing the whole of the experimental equipment for obtaining the depth of a damage mark given onto an optical disk through a collision test. An optical pickup actuator resulting from a modification made to an optical pickup actuator which is removed from an optical disk drive unit UJDA-710 manufactured by Panasonic Communications Co., Ltd. is used for an optical pickup actuator 122 used in experimental equipment 121 shown in FIGS. 11 and 12.

As shown in FIG. 11, on an objective lens holder 123 of the optical pickup actuator 122 removed from the disk drive unit UJDA-710 manufactured by Panasonic Communications Co., Ltd., a test piece 124 on which a protective member is formed is mounted on an objective lens mounting portion 125 in place of an objective lens which should have been mounted originally.

The test piece 124 is made up of a base portion 126 and a protective member forming portion 127. The base portion 126 is sized so as to be just fitted in the objective lens mounting portion. For the protective member forming portion 127, protective member forming portions of different shapes are used properly depending on purposes, and a resin material is dropped onto the protective member forming portion 127 to form a protective member through polymerization. The optical pickup actuator 122 on which the test piece 124 configured as described above is mounted is set at a position shown in FIG. 12 relative to an optical disk 128 or is set so as to produce a distance of 0.3 mm between a distal end of the protective member of the test piece 124 and the optical disk 128 in such a state that the objective lens holder 123 is at rest. In addition, in order to prevent the fall of the test piece 124, the test piece 124 may be fixed to the objective lens mounting portion 125 of the objective lens holder 123 using, for example, an adhesive.

Using the experimental equipment 121 that has been described above, a collision test is to be carried out with the following points observed to obtain the depth of a damage mark inflicted onto the optical disk 128 and a wear amount of a protector surface layer material by causing the optical disk 128 to spin. Although not shown, there is a flexible substrate provided on the optical pickup actuator to which signals are imparted from an external unit to displace the objective lens holder 123 in a focusing direction and a tracking direction, and terminals are provided on the flexible substrate to which the various signals are imparted. By giving a sine-wave signal of a maximum voltage amplitude of 1.3V and a frequency of 2 kHz between two terminals among the terminals so provided which function to displace the objective lens holder 123 in the focusing direction, the objective lens holder 123 is caused to oscillate in a vertical direction, so as to cause the protective member forming portion 127 of the test piece 124 to collide against the same location on the optical disk 128 intermittently. In the case of the experimental equipment 121, the rotational speed of the optical disk 128 is adjusted so that the linear velocity at a location thereof where the protective member of the test piece 124 is brought into contact becomes 10.56 m/sec. The number of times of collision between the protective member forming portion 127 and the same location on the optical disk 128 is 500 times. In the experimental equipment 121 shown in FIGS. 11 and 12 which is set as has been described above, a contact time between the protective member and the optical disk 128 in a single collision is 0.2 second.

In an experiment carried out in the way described above, the depth of a damage mark inflicted onto the optical disk 128 was measured and the result of the measurement was made to be a damage mark depth in the damage infliction test.

In addition, a Japanese DVD-R which was not treated with a hard coating was used as the optical disk in this experiment. An optical interference three-dimensional measuring machine manufactured by Micromap was used to measure the depth of a damage mark.

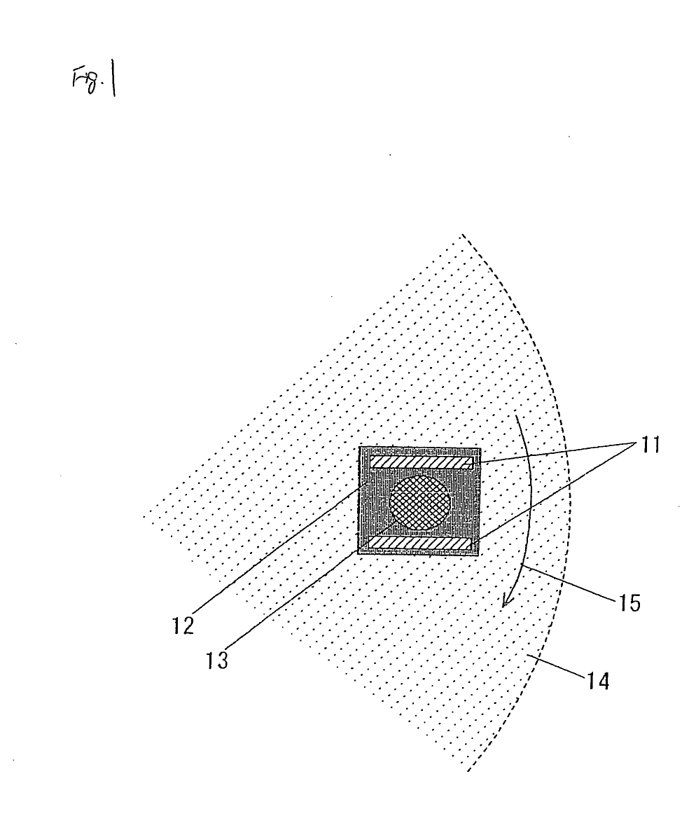

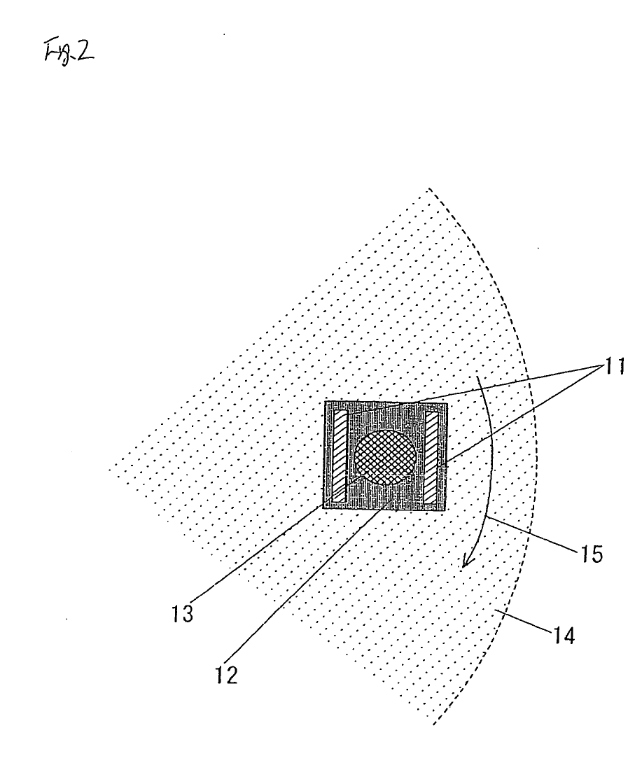

A protector and a lens holder according to an embodiment of the invention are shown in FIG. 1, and those according to a comparison example are shown in FIG. 2. In general, when a protector 11 collides against a storage disk 14, a stress resulting from the contact is considered to be dispersed to a greater extent as the contact area increases. In this case, as shown in FIG. 1, a resulting damage mark can be reduced by making a longitudinal direction of the protector 11 parallel to a straight line which connects the rotational center of a spindle 25 which constitutes the rotational center of the storage disk 14 with the center of an objective lens 13 which is an objective member. In other words, the longitudinal direction of the protector 11 is disposed parallel to a rotational axis of the storage disk 14 and a plane which passes through the center of the objective lens 13. Furthermore, in other words, the longitudinal direction of the protector 11 is disposed parallel to a radial direction of the storage disk 14. Furthermore, in other words, the longitudinal direction of the protector 11 is disposed parallel to a direction which extends across data tracks of the storage disk 14.

When used herein, parallel means that the length of the longitudinal, data-track traversing direction of the protector 11 is longer than the length of a tangential direction of the protector 11 to the data tracks, and the longitudinal direction of the protector 11 may only has to be within +/−45° relative to a rotational normal of the storage disk 14. By disposing the longitudinal direction of the protector 11 parallel to the direction which extends across the data tracks lying in a location on the storage disk 14 which the protector 11 is made to face, the length of the tangential direction of the protector 11 to the data tracks can be minimized, thereby making it possible to reduce the infliction of a damage to the storage disk. This effect increases as an angle relative to the rotational normal of the storage disk 14 decreases, whereby the infliction of a damage to the storage disk can be reduced further.

By adopting the configuration described above, while the contact area between the protector and the storage disk is increased, an opportunity where the protector is brought into contact with the same location on the storage disk can be reduced, whereby it becomes possible to reduce the damage to the storage disk due to a collision that would be able to occur between the protector and the storage disk while data is being written to or read out of the storage disk.

In addition, when the longitudinal direction of the protector 11 is disposed parallel to a tangent to the rotational direction of the storage disk 14 as shown in FIG. 2, a damage to the storage disk 14 becomes larger than with a protector 11 whose contact area with the storage disk 14 is reduced as with Comparison Example 1, which will be described later on. Data on the depth of a damage mark inflicted on the storage disk by the protector according to the embodiment of the invention is shown in (Table 1), the data including for comparison depths of damage marks inflicted by comparison examples. Comparison Example 1 is a protector in which a tangential direction of the protector to the rotational direction of the storage disk is substantially equal to a normal direction thereof to the rotational direction of the storage disk, while Embodiment 1 is a protector which is made to extend longer in the tangential direction of the protector to the rotational direction of the storage disk. When comparing Example 1 with Comparison Example 1, the depth of a damage mark in Example 1 is suppressed to on the order of one tenth the depth of a damage mark in Comparison Example 1. This is because the damage to the storage disk is considered to be suppressed by an increased contact area between the storage disk and the protector. Comparison Example 2 is such that the protector of Example 1 is disposed to extend in the tangential direction to the rotational direction of the storage disk, and although the contact area is increased in this case, a damage inflicted on the storage disk is increased. It is seen from this that when attempting to increase the contact area between the storage disk and the protector, it is much effective to form the protector in such a manner as that the normal direction thereof to the rotational direction of the storage disk is elongated.

Since the storage disk spins, it is considered that the longer the normal direction of the protector to the rotational direction of the storage disk is elongated the longer the length of the protector becomes which comes into contact with the same location on the storage disk, and the damage inflicted on the storage disk is increased. Due to this, it is considered that an opportunity is reduced in which the protector comes into contact with the same location on the storage disk by making the longitudinal direction of the protector provided on the holder parallel to a straight line which connects the rotational center of the rotational driving member with the center of the objective member and that the damage to the storage disk can be reduced compared to a case where the longitudinal direction of the protector is made normal to the straight line.

TABLE 1

| Samples | Damage Mark Depths (nm) |
|---|---|
| (Example 1) | 23 |
| (Comparison Example 1) | 220 |
| (Comparison Example 2) | 417 |

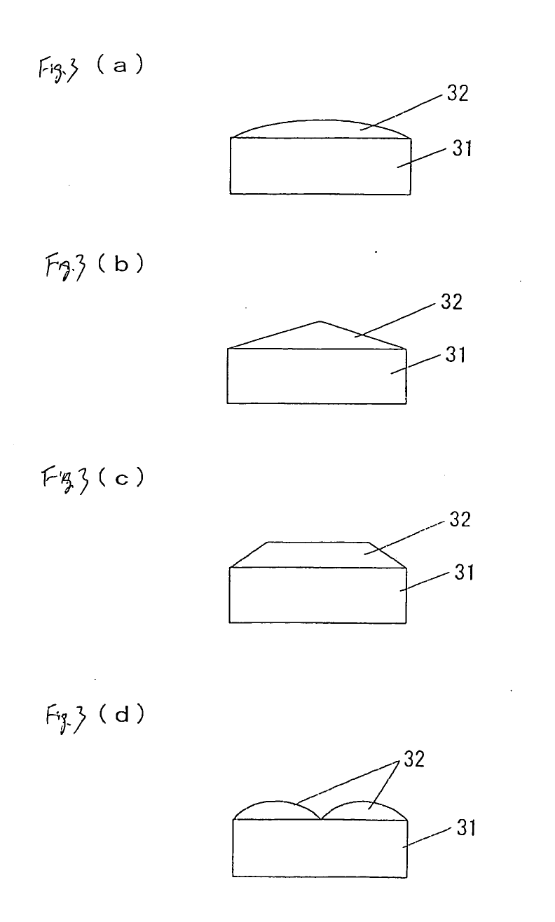

FIG. 3 shows examples of cross sections of the protector according to the embodiment of the invention which are taken along a shorter side or widthwise. While as the length of the protector along the shorter side thereof becomes shorter, the opportunity of the protector coming into contact with the same location on the storage disk can be reduced, with the protector formed into a shape in which the cross section of the protector becomes rectangular, in the event that the length of the shorter side of the protector is made short, the strength of the protector is deteriorated, resulting in the failure of the protector. As shown in FIGS. 3(a) to (c), by forming the protector in such a manner that the cross section thereof takes a shape which protrudes towards the storage disk or is formed into a shape which widens towards its bottom, the strength of the protector is increased while the contact point with the storage disk is reduced. In addition, as shown in FIG. 3(d), a shape is also effective in which a plurality of convex shapes are aligned. With the shapes which protrude towards the storage disk, air flowing in the direction of the protector is compressed by a flow of air generated by the rotation of the storage disk, whereby a repulsion force is generated between the storage disk and the protector, and there is also provided an advantage that an impact generated by a collision can be reduced. In this case, when the cross section taken along the shorter side of the protector includes an arc-like shape, air flows in smoothly, increasing the advantage of reducing the impact. Namely, buoyancy is generated by air generated by the rotation of the storage disk, whereby the impact caused when the protector comes into collision with the storage disk can be mitigated.

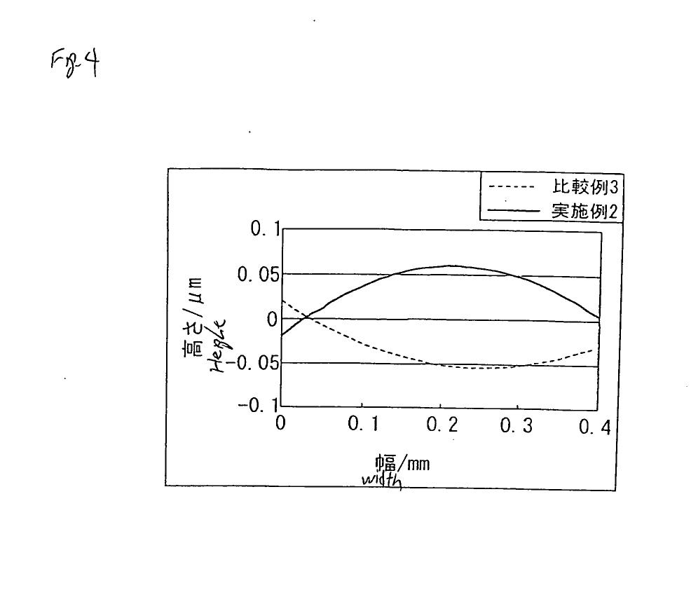

Data on the depth of a damage mark inflicted on the storage disk by the protector according to the embodiment of the invention is shown in (Table 2), the data including for comparison the depth of a damage mark inflicted by a comparison example. Data resulting from actual measurements of cross sectional shapes of Example 2 and Comparison Example 3 are shown in FIG. 4. It is seen that with a shape which protrudes towards the storage disk like Example 2, the damage to the storage disk can be reduced largely.

TABLE 2

| Samples | Damage Mark Depths (nm) |
|---|---|
| (Example 2) | 21 |
| (Comparison Example 3) | 296 |

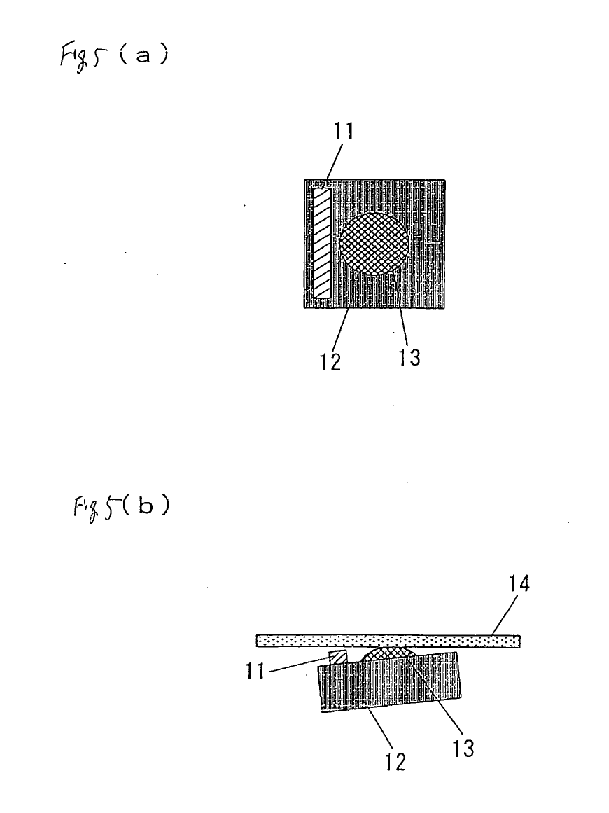

FIG. 5 shows an exemplary diagram of a lens holder having only one protector. With only one protector provided, as shown in FIG. 5(b), there is caused a risk that the objective lens or the lens holder comes into collision with the storage disk earlier than the protector. Due to this, when at least two protectors are provided on both the sides of the objective lens as shown in FIG. 1, the collision of the objective lens or the lens holder with the storage disk can be prevented. Although there is no specific limitation on the number of protectors because with two or more protectors provided, the intended object can be attained, the number of protectors to be provided is suitably in the range from 2 to 4 when considering the productivity. When a pair of protectors are positioned in such a manner as to hold the objective lens therebetween while being arranged in the tangential direction to the rotational direction of the storage disk, the objective lens or the lens holder can be prevented from coming into collision with the storage disk.

Thus, by providing the protectors on both the sides of the objective lens, the objective member or the holder can be prevented from coming into collision with the storage disk earlier than the protectors.

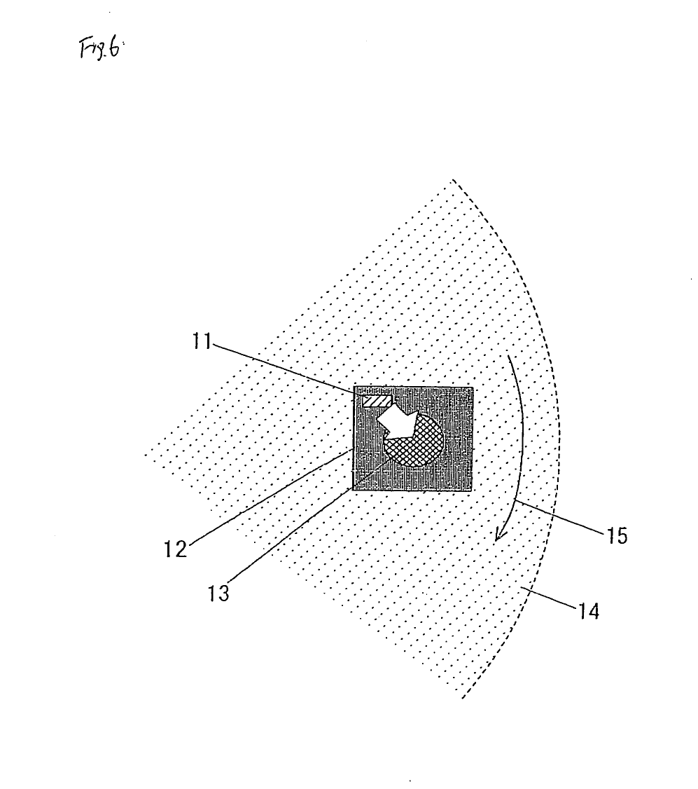

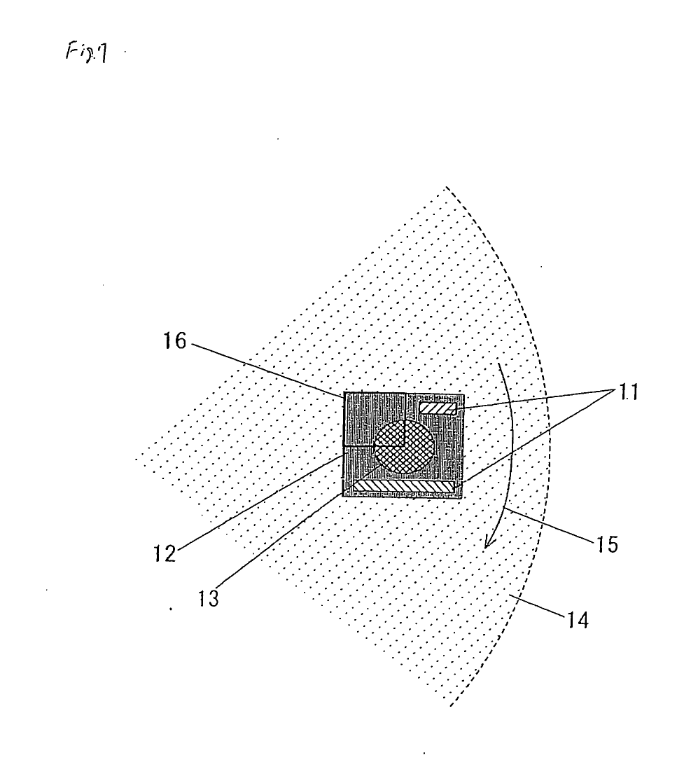

FIG. 6 shows an exemplary diagram of the lens holder. In the event that a protector resides at a position shown in FIG. 6, fragments of the protector generated by a collision of the protector with the storage disk are thrown in a direction indicated by an arrow, resulting in a high possibility that the fragments so thrown adhere on to the objective lens. Consequently, the fragment can effectively be prevented from being thrown on to the objective lens by attempting not to dispose the protector in an area on the lens holder which is defined as lying further upstream in the rotational direction and radially closer to a rotational center of the storage disk than the objective lens. To describe specifically, the objective lens can be prevented from getting dirty to thereby increase the reliability in wiring or reading data by attempting not to dispose the protector in an area 16 which is surrounded by a square in FIG. 7.

Thus, by disposing the protector at a position which lies on the holder except for the area defined as lying further upstream in the rotational direction and radially closer to the rotational center of the storage disk than the objective member, the fragments that are generated by the collision between the protector and the storage disk can be prevented from adhering on to the objective member.

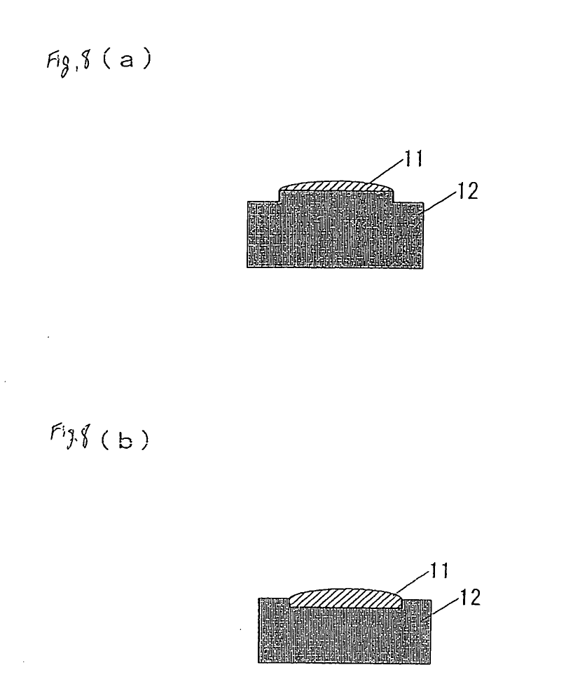

FIG. 8 shows exemplary diagrams of the protective member forming portion of the lens holder 12. As shown in FIG. 8, the protective member can be prevented from flowing to other locations by raising or lowering the portion where the protective member is to be formed, and the protective member forming area can be controlled easily. By utilizing this method, the shape of the protective member can be controlled with good accuracy even by a simple and highly productive production method like one in which a protective member is dropped to be cured using a dispenser or the like.

While in general, a highly rigid and hard material is used for the lens holder 12, by making up the protector 11 of the protective member which is formed on the base material which makes up the lens holder 12, a soft material can be disposed on a surface which is brought into collision with the storage disk, and therefore, the damage to the storage disk can be reduced further. Furthermore, when a photo-setting urethane acrylate is used, the productivity can be increased and the production costs can be reduced.

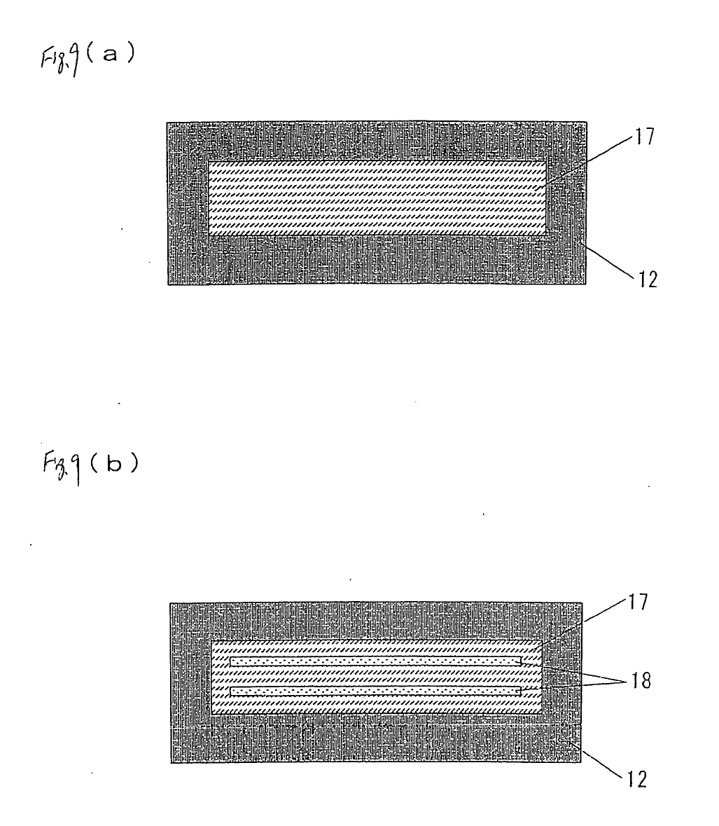

FIG. 9 shows exemplary diagrams of an upper surface of the protective member forming portion of the lens holder. When attempting to form a protective member on a protective member forming portion 17 having an elongated shape as shown in FIG. 9(a), there occurs a failure in which a protective member does not spread over the whole of the protective member forming portion but only part thereof is applied with the protective member. To solve the problem, when forming one or more grooves 18 on the protective member forming portion as shown in FIG. 9(b), the protective member is made to easily spread over the whole of the protective member forming portion 17, and the control of the shape thereof can be ensured.

Thus, by providing at least one groove on the protective member forming portion 17, when applying a protective member such as a resin material on to the holder with a dispenser or the like, since the protective member spreads quickly over the whole of the protective member forming portion, the application of the protective member can be facilitated, and the variability of the shape of the protective member applied can be suppressed.

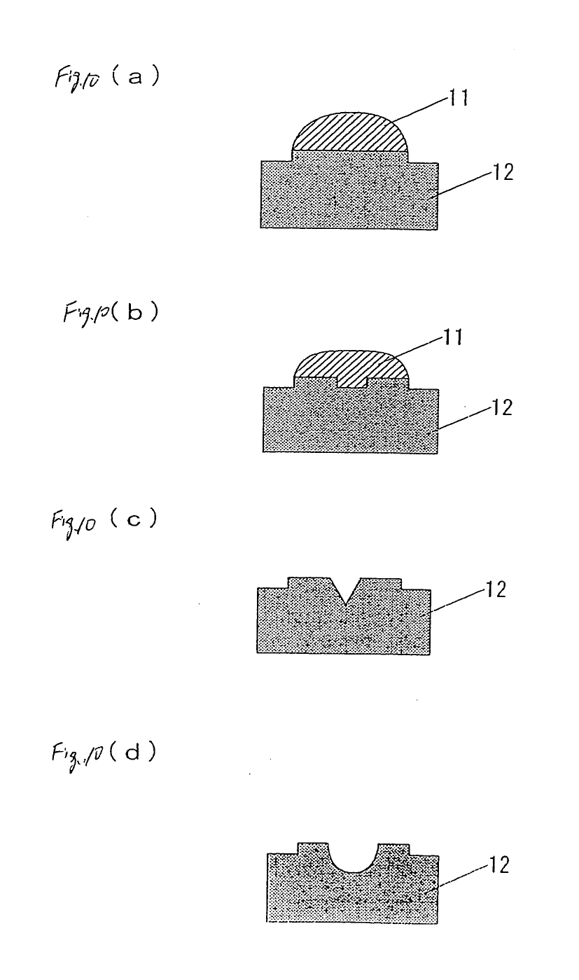

FIG. 10 shows exemplary diagrams of cross sections of the protective member forming portion of the lens holder which are taken along the longitudinal direction thereof. FIG. 10(a) shows an example in which no groove is formed on the protective member forming portion, and in case no special molding is implemented only with the protective member applied thereto, a center point is increased in height, and a longitudinal contact area between the storage disk and the protective member is reduced. When forming a groove which passes through the center of the protective member forming portion as shown in FIG. 10(b), there occurs a contraction when the protective member is polymerized, whereby the center point is slightly lowered in height, thereby making it possible to increase the contact area. When making use of this phenomenon, the shape of the protective member can freely be controlled according to purposes. There is no specific limitation on the shape of the groove 18 formed on the protective member forming portion, and hence, a groove which is triangular circular in cross section may be adopted as shown in FIGS. 10(c), (d).

Thus, by forming a straight or curved groove which passes through substantially the center of the protective member forming portion when viewed from the storage disk side, the shape of an apex of the protective member, that is, a portion which comes into collision with the storage disk can be controlled.

Next, an optical disk unit to which the protector 11 of the embodiment is applied will be described.

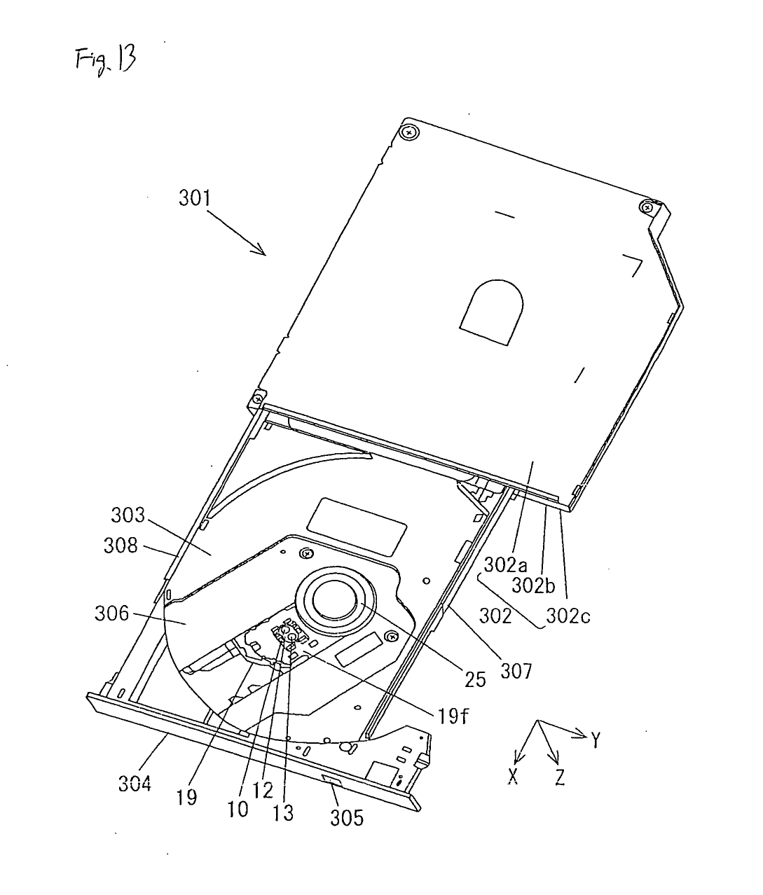

FIG. 13 is a drawing which shows an optical disk unit according to the embodiment of the invention. In an optical disk unit 301 shown in FIG. 13, reference numeral 302 denotes a cover, and the cover 302 is made up of an upper cover 302a and a lower cover 302b, and the cover 302 is made into a bag-like configuration having an opening 302c at one end portion thereof. In the cover 302, a tray 303 is held in such a manner as to be freely inserted and ejected in an X direction shown in FIG. 13, and the tray 303 is made of a material such as a resin material which is light in weight. A bezel 304 is provided on the tray 303 at a front portion thereof, and this bezel 304 is made to cover the opening 302c when the tray 303 is accommodated within the cover 302. An eject button 305 is exposed on the bezel 304, and when this eject button 305 is pressed, the tray 303 is ejected to protrude slightly from the cover 302 in the X direction shown in FIG. 13 by means of a mechanism, not shown, whereby the tray 303 is allowed to be pulled out or inserted into the cover 302 in the X direction.

A pickup module 306 is mounted on the tray 303. A spindle motor 25, which is a rotational driving member for rotationally driving an optical disk 2, is provided on the pickup module 306, and furthermore, and a base plate 19 is movably provided on the pickup module 306 in such a manner as to move towards or away from the spindle motor 25. Although a detailed description will be made later on, a lens holder 12 is provided on the base plate 19 in such a manner as to be move elastically relative to the base plate 19. In the base plate 19, a base plate cover 19f is mounted on a surface facing an information writeable or recordable surface of the optical disk 2 which is attached to the spindle motor 25, so as to cover at least part of components such as a flexible substrate 29, the lens holder 12 and the like which are mounted on the base plate 19, whereby the components mounted on the base plate 19 can be prevented from coming into contact with the optical disk 2, and on the contrary, these components can be protected against dust and electrical noise.

Reference numerals 307, 308 denote rails which are held on the lower cover 302b and, moreover, are brought into engagement with both side portions of the tray 303, respectively. The rails 307, 308 are made to slide in the X direction in which the tray 303 is inserted and ejected within a predetermined range relative to the lower cover 302b and the tray 303.

Next, the base plate 19 provided on the pickup module 306 will be described in greater detail.

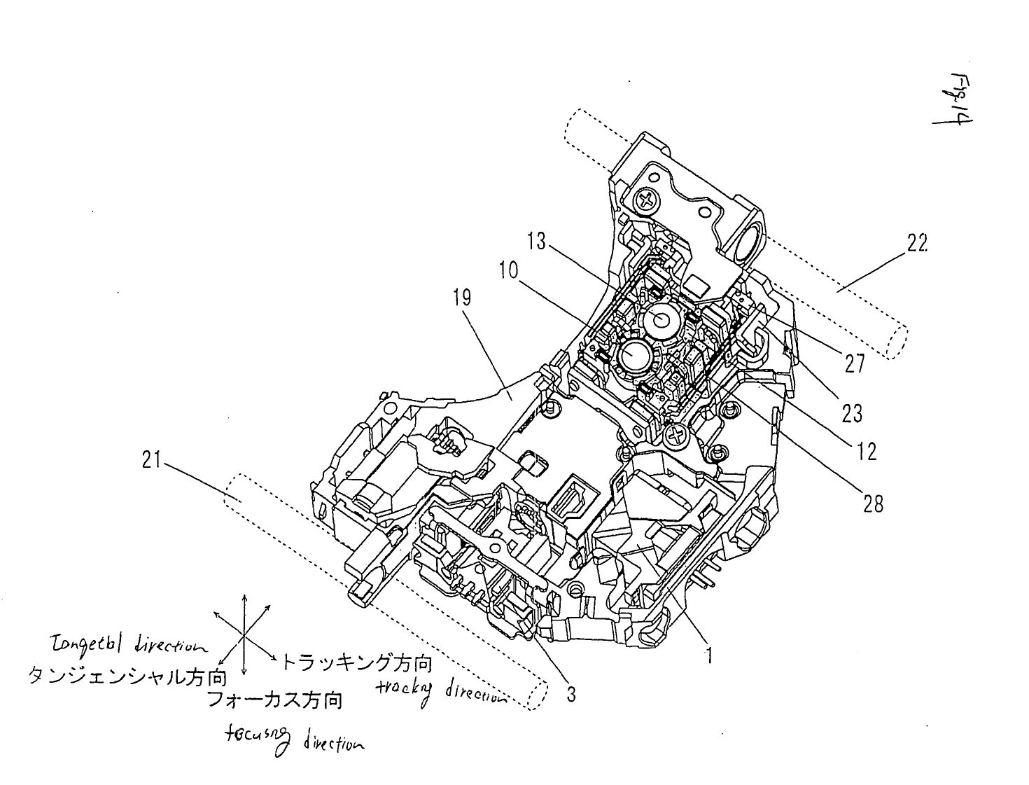

FIG. 14 is an overall perspective view of the base plate 19. Note that the base plate 19 is shown in such a state that the components such as the base plate cover 19f and the flexible substrate are removed from the base plate 19 for the purpose of explanation. In addition, in the figure, a focusing direction denotes a direction in an optic axis direction of objective lenses 10, 13. The focusing direction is also a direction which is parallel to a rotational axis of the spindle motor 25. A tracking direction is a direction which is parallel to a surface of a suspension holder 27 to which a suspension 28 is fixed and which is normal to the focusing direction. A tangential direction is a direction which is normal to both the focusing direction and the tracking direction.

The base plate 19 is movably mounted on shafts 21, 22.

In general, a short-wavelength optical unit 1 for emitting and receiving short-wavelength light, a long-wavelength optical unit 3 for emitting and receiving long-wavelength light and the lens holder 12 on which the objective lenses 10, 13 are mounted are provided on the base plate 19.

The lens holder 12 is elastically supported on the suspension holder 27 by the suspension 28. The suspension holder 27 is fixed to a yoke member 23 by means of a method such as bonding, and the yoke member 23 is also joined to the base plate 19 by means of a method such as bonding.

Next, the configuration of the lens holder 12 will be described in greater detail.

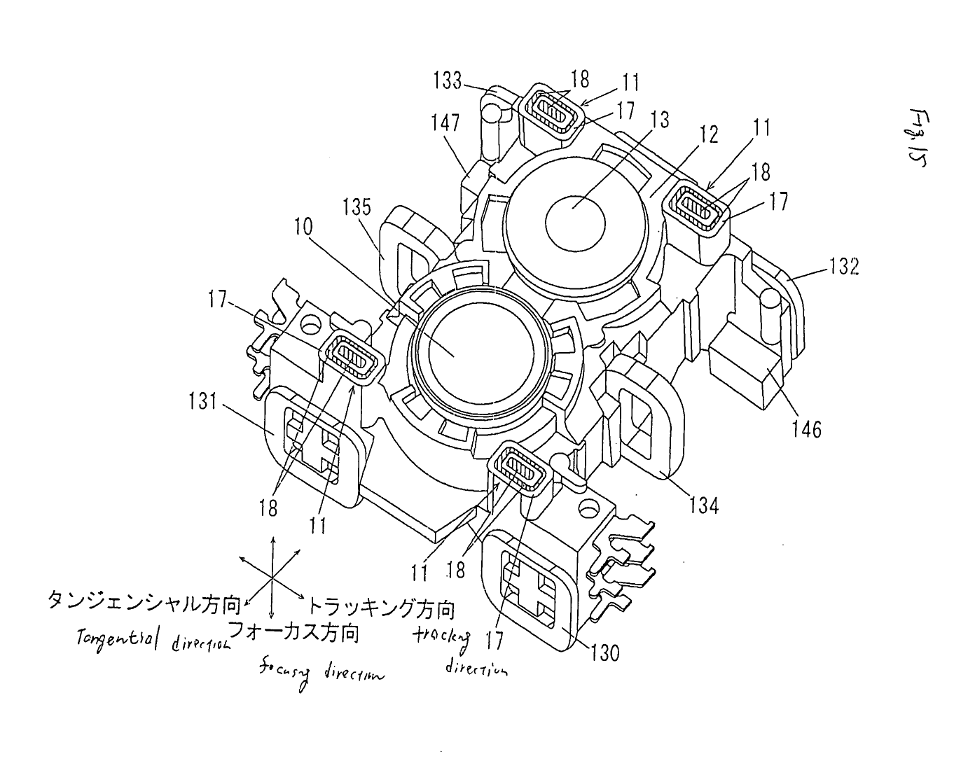

FIG. 15 is a drawing which shows a movable portion of an optical pickup unit of the embodiment of the invention.

As shown in FIG. 15, the objective lenses 10, 13, which are objective members, focusing coils 130, 131, 132, 133, tracking coils 134, 135, mass balancers 146, 147, an optical component, a color killer diffraction lens, a one fourth wavelength plate and the like are provided on the lens holder 12 which is a movable portion of the optical pickup unit of the embodiment for driving the objective lenses 10, 13, the optical component, the color killer diffraction lens and the one fourth wavelength plate being not shown in the drawing.

In addition, protectors 11 are provided in such a manner as to surround the objective lenses 10, 13, and a longitudinal direction of each of the protectors 11 so provided is disposed parallel to the tracking direction. As shown shaded with oblique lines in FIG. 15, a straight groove 18 which passes through substantially the center of a protective member forming portion 17 and a groove 18 which is provided in such a manner as to surround the straight groove 18 are provided on the protector 11.

Note that while in this embodiment, the objective lenses 10, 13 are described as being used as the objective members which face the storage disk 14 and the lens holder 12 is described as being used as the holder having the objective members and the protectors 11, the objective members and the holder are not limited thereto and are, hence, altered properly according to the type of storage disk 14 such as a hard disk or an MO which reads or writes information.

### EXAMPLES

Hereinafter, examples of the invention will be described.

### Example 1

A photo-setting urethane acrylate resin was applied using a dispenser to a test piece having a protective member forming portion 17 which is formed into 1 mm×2 mm in such a manner as to realize an apex height of the order of 300 μm, and the resin material so applied is exposed by on the order of 500 mJ by means of a UV emitting machine so as to be set. The resin material so set was attached to an objective lens holder with an adhesive in such a manner that a longitudinal direction thereof becomes normal to the rotational direction of the storage disk, and a surface of the resin material was sanded with a sanding disk in such a manner as to realize a height of the order of 150 μm. The test piece so completed was made as Example 1.

### Example 2

A photo-setting urethane acrylate resin was applied using a dispenser to a test piece having a protective member forming portion 17 which is formed into 0.5 mm×2 mm in such a manner as to realize an apex height of the order of 300 μm, and the resin material so applied is exposed by on the order of 500 mJ by means of the UV emitting machine so as to be set. The resin material so set was attached to an objective lens holder with an adhesive in such a manner that a longitudinal direction thereof becomes normal to the rotational direction of the storage disk, and a surface of the resin material was sanded with a sanding disk in such a manner as to realize a height of the order of 150 μm. The test piece so completed was made as Example 2.

### Comparison Example 1

A photo-setting urethane acrylate resin was applied using a dispenser to a test piece having a protective member forming portion 17 which is formed into 1 mm×1 mm in such a manner as to realize an apex height of the order of 300 μm, and the resin material so applied is exposed by on the order of 500 mJ by means of the UV emitting machine so as to be set. The resin material so set was attached to an objective lens holder with an adhesive in such a manner that a longitudinal direction thereof becomes normal to the rotational direction of the storage disk, and a surface of the resin material was sanded with a sanding disk in such a manner as to realize a height of the order of 150 μm. The test piece so completed was made as Comparison Example 1.

### Comparison Example 2

A photo-setting urethane acrylate resin was applied using a dispenser to a test piece having a protective member forming portion 17 which is formed into 1 mm×2 mm in such a manner as to realize an apex height of the order of 300 (m, and the resin material so applied is exposed by on the order of 500 mJ by means of the UV emitting machine so as to be set. The resin material so set was attached to an objective lens holder with an adhesive in such a manner that a longitudinal direction thereof becomes tangential to the rotational direction of the storage disk, and a surface of the resin material was sanded with a sanding disk in such a manner as to realize a height of the order of 150(m. The test piece so completed was made as Comparison Example 2.

### Comparison Example 3

A photo-setting urethane acrylate resin was applied using a dispenser to a test piece having a protective member forming portion 17 which is formed into 0.5 mm×2 mm in such a manner as to realize an apex height of the order of 300 (m, and the resin material so applied is exposed by on the order of 1 mJ by means of the UV emitting machine so that a surface of the resin is set. The resin material so set was attached to an objective lens holder with an adhesive in such a manner that a longitudinal direction thereof becomes normal to the rotational direction of the storage disk, and the resin material so attached is then exposed by on the order of 500 mJ in such a state that a crystal plate is pressed thereagainst so as to realize a height of the order of 150 (m, whereby the resin material was set completely. Then, the crystal plate was removed from the resin material, and the test piece so completed was made as Comparison Example 3.

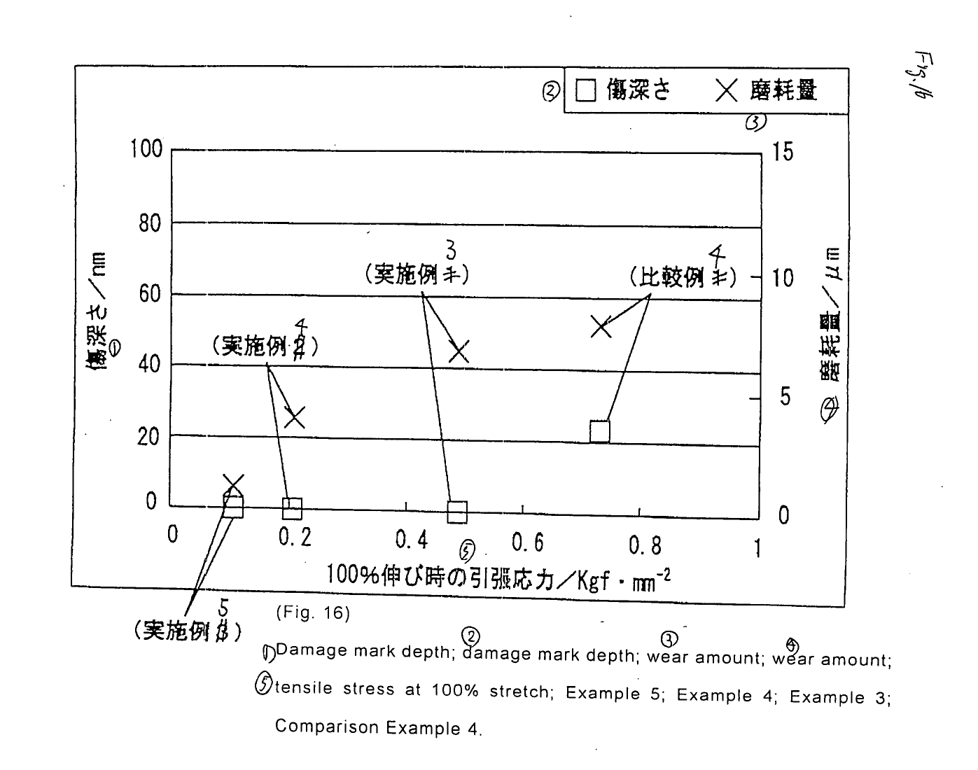

Next, a protective member to be formed on a base material of the lens holder 12 will be described in detail using FIGS. 16 to 20.

The experimental equipment shown in FIG. 11 was used for a collision test that was carried out to obtain the depth of a damage mark on the optical disk and the amount of wear of a protector surface layer material.

As shown in FIG. 11, on an objective lens holder 123 of an optical pickup actuator 122 removed from a disk drive unit UJDA-710 manufactured by Panasonic Communications Co., Ltd., a test piece 124 on which a protective member is formed is mounted on an objective lens mounting portion 125 in place of an objective lens which should have been mounted originally.

The test piece 124 is made up of a base portion 126 and a protective member forming portion 127. The base portion 126 is sized so as to be just fitted in the objective lens mounting portion. Here, the protective member forming portion 127 has a diameter of 1 mm and a height of 1 mm, and a resin material is dropped onto the protective member forming portion 127 to form a protective member through polymerization. The protective member so formed is then formed into a spherical shape having a maximum thickness of about 100 (m. The optical pickup actuator 122 on which the test piece 124 configured as described above is mounted is set at a position shown in FIG. 12 relative to an optical disk 128 or is set so as to produce a distance of 0.3 mm between a distal end of the protective member of the test piece 124 and the optical disk 128 in such a state that the objective lens holder 123 is at rest. In addition, in order to prevent the fall of the test piece 124, the test piece 124 may be fixed to the objective lens mounting portion 125 of the objective lens holder 123 using, for example, an adhesive.

Using the experimental equipment 121 that has been described above, a collision test is to be carried out with the following points observed to obtain the depth of a damage mark inflicted onto the optical disk 128 and the amount of wear of a protector surface layer material by causing the optical disk 128 to spin. Although not shown, there is a flexible substrate provided on the optical pickup actuator to which signals are imparted from an external unit to displace the objective lens holder 123 in a focusing direction and a tracking direction, and terminals are provided on the flexible substrate to which the various signals are imparted. By giving a sine-wave signal of a maximum voltage amplitude of 1.3V and a frequency of 2 kHz between two terminals among the terminals so provided which function to displace the objective lens holder 123 in the focusing direction, the objective lens holder 123 is caused to oscillate in a vertical direction, so as to cause the protective member forming portion 127 of the test piece 124 to collide against the same location on the optical disk 128 intermittently. In the case of the experimental equipment 121, the rotational speed of the optical disk 128 is adjusted so that the linear velocity at a location thereof where the protective member of the test piece 124 is brought into contact becomes 10.56 m/sec. The number of times of collision between the protective member forming portion 127 and the same location on the optical disk 128 is 500 times. In the experimental equipment 121 shown in FIGS. 11 and 12 which is set as has been described above, a contact time between the protective member and the optical disk 128 in a single collision is 0.2 second.

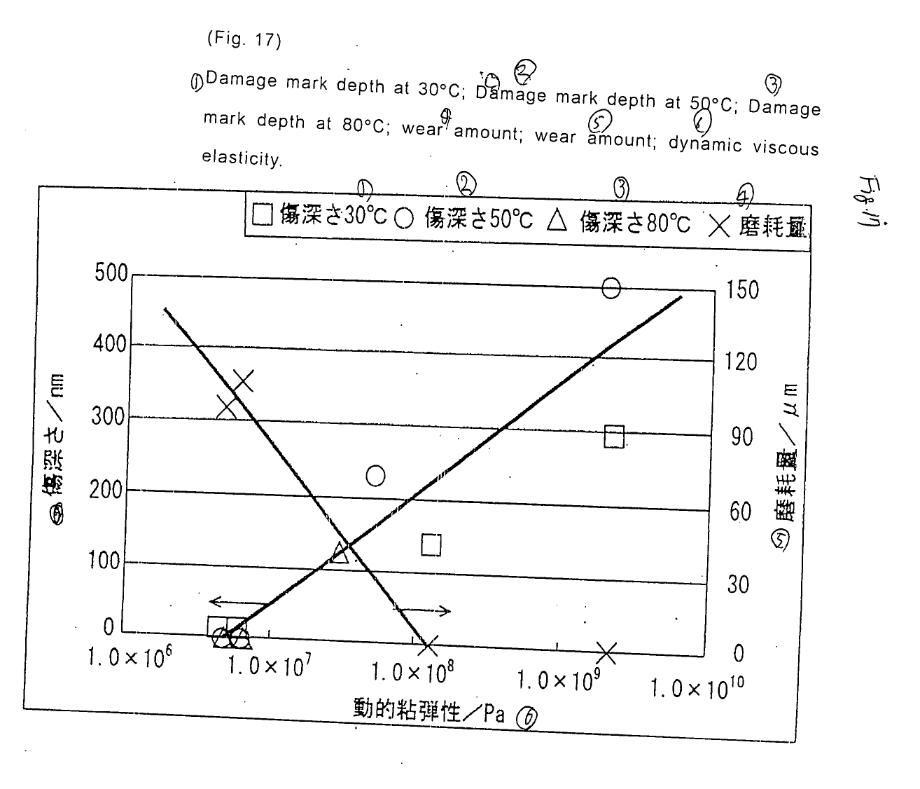

In an experiment carried out in the way described above, the depth of a damage mark inflicted onto the optical disk 128 and the amount of wear of the protective member were measured and the results of the measurements are shown in FIGS. 16 and 17 as damage mark depths and wear amounts.

In addition, a Japanese DVD-R which was not treated with a hard coating was used as the optical disk in this experiment. An optical interference three-dimensional measuring machine manufactured by Micromap was used to measure the depth of the damage marks. The wear amounts were obtained by measuring the thickness of the protective member before and after the experiment from a side thereof using a microscope.

In addition, a DMS110 manufactured by Seiko Co., Ltd. was used to measure dynamic viscous elasticity, and an AUTOGRAPH DCS-50M manufactured by Shimazu Seisakusho Co., Ltd. was used to measure tensile stress and breaking strength, and those so measured will be discussed below.

FIG. 16 shows a graph which plots a damage mark depth and a wear amount relative to a tensile stress at 100% stretch, and FIG. 17 shows a graph which plots a damage mark depth and a wear amount relative to dynamic viscous elasticity. In addition, numerical data on the damage mark depths plotted in FIGS. 16 and 17 are shown in (Table 3). According to the data, the damage inflicted on the optical disk decreased as the dynamic viscous elasticity or the tensile stress at 100% stretch of the protective member decreased, and when attempting to describe this fact in a general expression, it is said that the softer the protective member becomes, the smaller the damage mark inflicted on the optical disk becomes. In particular, when the tensile stress at 100% stretch was 0.49 kgf/mm2 or smaller, the depth of the damage mark inflicted on the optical disk became 0 nm. The dynamic viscous elasticity then was 3.7×10⁶ Pa, and it can be said that with a protective member which is softer than this, no damage mark would have been inflicted on the optical disk under this experimental conditions.

TABLE 3

| | | Tensile Stress at | |
|---|---|---|---|
| | Dynamic Viscous | 100% Stretch | Damage Mark |
| | Elasticity(Pa) | (Kgf/mm2) | Depth (nm) |
| (Comparison | 2.9 × 10⁹ | | 295 |
| Example 8) | | | |
| (Comparison | 1.2 × 10⁸ | | 140 |
| Example 7) | | | |
| (Comparison | 5.8 × 10⁶ | | 12 |
| Example 6) | | | |
| (Comparison | 4.6 × 10⁶ | | 12 |
| Example 5) | | | |
| (Comparison | 4.6 × 10⁶ | 0.73 | 74 |
| Example 4) | | | |
| (Comparison | 3.7 × 10⁶ | 0.49 | 0 |
| Example 3) | | | |
| (Comparison | | 0.21 | 0 |
| Example 4) | | | |
| (Comparison | | 0.11 | 0 |
| Example 5) | | | |

It is seen in FIG. 17 that when the dynamic viscous elasticity decreases, the wear amount of the protective member increases. This can be said to be an inevitable result because it can easily be assumed that when the film gets soft, its toughness is lost, and the protective member tends to wear easily. Although a limit wear amount of the protective member is determined by the design of an optical pickup actuator, with a Blu-ray disk (BD) whose working distance is small, there occurs a risk that the objective lens comes into collision with the optical disk, and a wear amount of the order of 10 μm is considered to be a limit. According to the data shown in FIG. 16, the dynamic viscous elasticity of Comparison Example 4 is 4.6×10⁶ Pa, and the dynamic viscous elasticity of Comparison Example 3 is 4.6×10⁶ Pa, and it is clear that the wear amounts thereof are small as materials having substantially the same dynamic viscous elasticity or tensile stress at 100% stretch. While FIG. 4 shows a relationship between breaking strength and wear amount, it is clear from what is shown therein that the wear amount decreases as the breaking strength increases. From this, the wear amount can be suppressed to 10 μm or smaller with the breaking strength being 0.43 kgf/mm² or larger, and an optical disk such as BD which has the small working distance can be used.

TABLE 4

| | Breaking Strength | Wear Amount |
|---|---|---|
| | (kgf/mm) | (μm) |
| (Comparison Example 4) | 0.43 | 7.75 |
| (Example 3) | 0.49 | 6.65 |
| (Example 4) | 0.71 | 3.88 |
| (Example 5) | 1.72 | 1.00 |

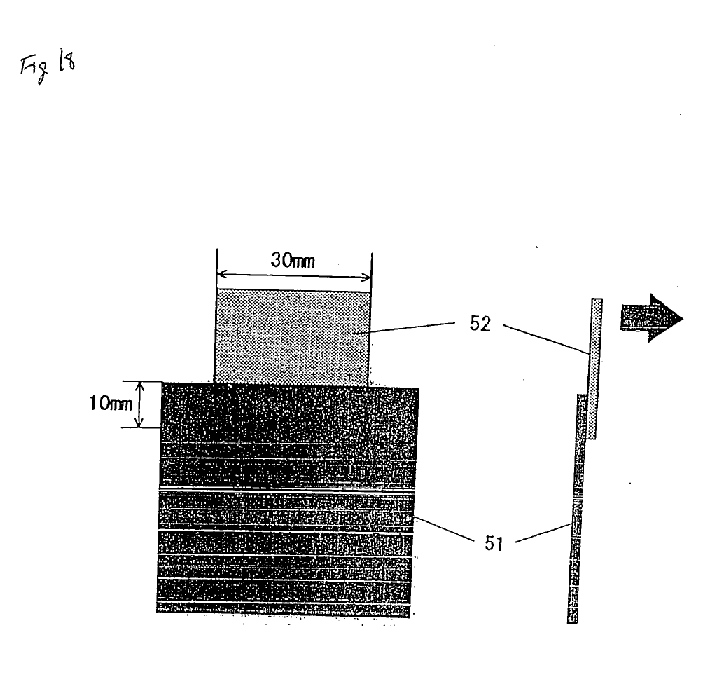

FIG. 18 is an exemplary diagram showing a method for measuring bonding strength. A liquid crystal polymer plate 51 and a polycarbonate plate 52 are affixed to each other so that an overlapping portion becomes 3 cm² using a polymer which is used as a protective member. An end portion of the polycarbonate plate so affixed was pulled by a push-pull gauge and a value obtained by dividing a stress resulting when the plate was separated by the overlapping area was made to be a bonding strength. Polymers used in this test are made by adding properly monomers shown in (Table 7) and (Table 8) and photopolymerization initiators shown in (Table 9) to urethane acrylates shown in (Table 5) by adjusting volumes thereof according to applications, mixing them in a water bath and getting the mixture polymerized.

TABLE 5

| Manufactures | Trade Names | Product Nos. |
|---|---|---|
| Toa Gosei Chemicals | ARONICS | M-1100 |
| | | M-1200 |
| | | M-1210 |
| | | M-1310 |
| | | M-1600 |
| Mitsui Takeda Chemicals | TAKERAC | UV-1050 |
| | | UV-1070 |
| | | UV-6012N |
| | | UV-6012NB |
| | | UV-6013 |
| | | UV-6023 |
| | | UV-6026 |
| | | UV-6030 |
| | | UV-6030 |
| | | UV-6033S |
| | | UV-6034N |
| | | UV-6040 |
| | | UV-9203 |

TABLE 6

| Chemical Designation | Structural Formula |
|---|---|
| Phenol EO modified acrylate | 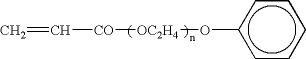 |
| Nonyl Phenol EO modified acrylate | 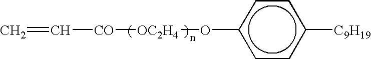 |
| Bisphenol AEO modified diacrylate | 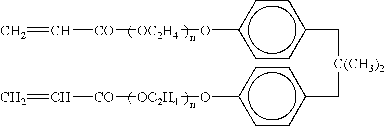 |
| Isobornyl acrylate | 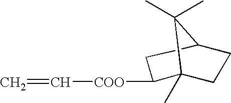 |
| Isobornyl methacrylate | 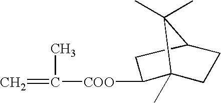 |
| N-vinyl-2-pyrrolidone | 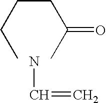 |
| Benzyl methacrylate | 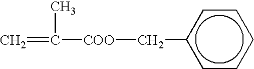 |
| Neopentyl glycol acrylic benzoate | 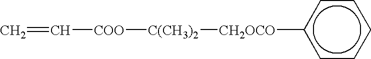 |

TABLE 7

| Chemical Designation | Structure Formula |
|---|---|
| 2-hydroxy acrylate | 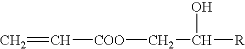 |
| 2-hydroxy methacrylate | 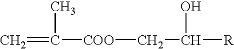 |

TABLE 8

| Chemical Designation | Structural Formula |
|---|---|
| 2,2-dimethosy- 1,2-diphenylethane-1-on | 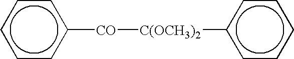 |
| 1-hydroxy-cyclohexyl- Phenyl-ketone | 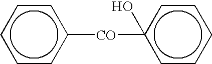 |
| Benzophenone | 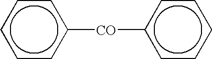 |
| 2-methyl-1-[4-(methylthio)phenyl]- 2-monphelinopropane | 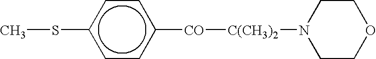 |
| 2-benzyl-2-dimethylamino- 1-(4-moliphelinophenyl)-butanone-1 | 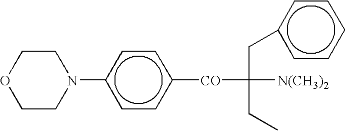 |
| 2-hydroxy-2-methyl- 1-phenyl-propane-1-on | 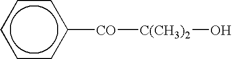 |
| 1-[4-(2-hydroxyethoxy)phenyl]- 2-hydroxy-2-methyl-1-propane-1-on | 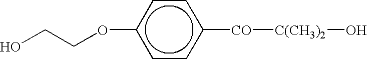 |

TABLE 9

| Manufactures | Product Names |
|---|---|
| Shinetsu Chemicals | KP-356 |
| | KP-357 |
| | KP-358 |
| | KP-359 |
| Big Chemy Japan | BYK-300 |
| | BYK-310 |
| | BYK-315 |
| | BYK-320 |
| | BYK-322 |
| | BYK-330 |
| | BYK-340 |
| | BYK-344 |
| | BYK-350 |
| | BYK-354 |
| | BYK-UV3500 |
| | BYK-UV3510 |
| | BYK-UV3570 |

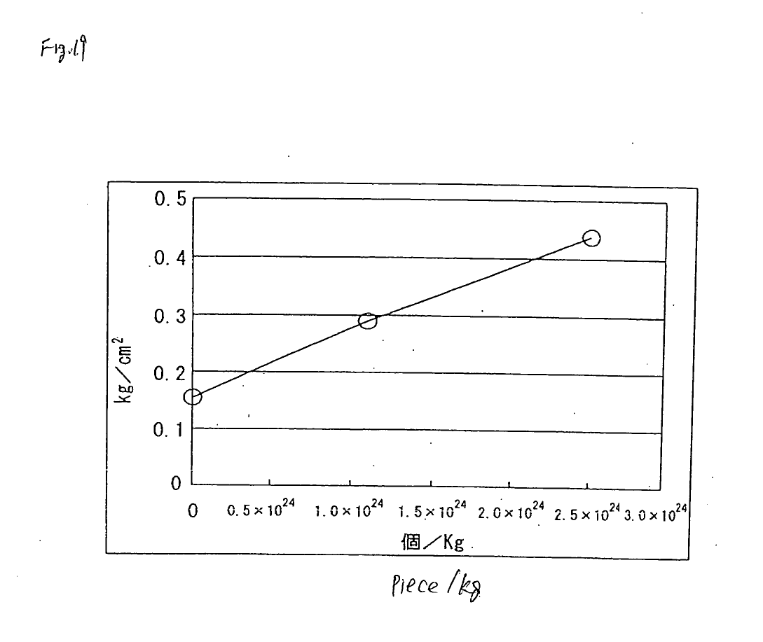

FIG. 19 shows a graph which plots a relationship between bonding strength and the number of hydroxyl groups contained in a polymer. It is seen from this that with a hydroxyl group contained, the bonding strength increases and that the bonding strength increases as the amount of hydroxyl group increases. While the bonding strength varies depending on kinds and volumes of materials, since the same tendency as that resulting from this experiment is obtained in the event that an experiment is carried out by adjusting the amount of hydroxyl group using a material of the same system, no example as the protective member is raised here.

By using protective members like those raised as Example 3, Example 4, Example 5, the objective lens collision preventive protector portion 112 not only protects the objective lens 110 and the optical disk 101 against damage but also makes itself a material which has superior wear resistance. By making the objective lens collision preventive protector portion 112 the material which is difficult to wear, a time is extended which is to be spent from its original state (a state in which an interval between the optical disk 101 and the objective lens 110 is larger than an interval between the optical disk 110 and the objective lens collision preventive protector portion 112) until the objective lens collision preventive protector portion 112 wears due to collision with the optical disk 101, and the continuity of the function to protect the objective lens 110 is extended further. In addition, by making the objective lens collision preventive protector portion 112 difficult to wear, the amount of the constituent components of the objective lens collision preventive protector portion 112 which are separated from the protector portion due to its wear is reduced, and a risk of the constituent components so separated adhering to the optical disk 101 and/or the objective lens 110 is reduced, whereby the possibility of disruption of data reading or data writing to the optical disk 101 can be reduced.

Thus, the infliction of damage on the storage disk due to a collision between the lens holder or the objective lens with the storage disk can be reduced, and furthermore, the infliction of damage on the optical disk and adhesion of the protective member to the optical disk due to its wear can be reduced, whereby data reading from the storage disk or data writing to the optical disk can be performed over a long period of time in a stable fashion with fewer errors.

Being made of the soft material, the protective member illustrated in this embodiment absorbs an impact force generated when the lens holder collides against the storage disk, whereby the infliction of damage on the storage disk due to the collision between the protective member and the storage disk can be reduced. Furthermore, the use of the protective member having the large breaking strength can reduce the wear of the protective member, whereby the continuity of the function of the protective member can be extended, and the adhesion of the constituent fragments separated from the protective member to the optical disk can be reduced. In addition, since it has the soft and tough film quality, the protective member can be used for an impact absorbing member, a damage preventive member or the like. In particular, in storage disks such as optical disks, hard disks and MO's which are liable to be damaged easily, the infliction of damage on a storage disk due to a collision with a data recording/playing back unit can be reduced largely. The protective member of the invention is preferably applied, in particular, to the Blu-ray disk whose working distance is very small among those storage disks. In addition, since the protective member of the invention is good at bonding to a liquid crystal polymer, the protective member is advantageous in that the protective member is difficult to be separated or fall from the lens holder base material and can also be used as a liquid crystal polymer adhesive.

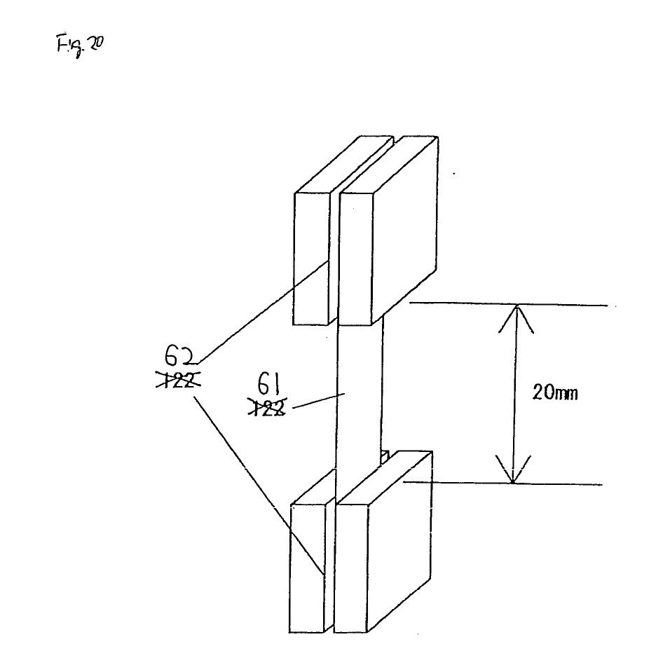

As has been described heretofore, by making the tensile stress at 100% stretch 0.49 kgf/mm² or smaller, the infliction of damage on storage disks such as optical disks, hard disks and MO's due to collision therewith can be reduced. Here, the tensile stress at 100% stretch will be described using FIG. 20. The protective member is formed into a strip-like film sample 61 of the order of 5 mm×40 mm×60 μm, and the film so formed is made to be chucked with chucking jigs 62 of a tensile tester at both ends thereof so that a film exposing portion becomes approximately 20 mm. Then, the film is pulled at the ends thereof at steady speed by the tensile tester for measurement of stress applied then, and a stress applied at 100% stretch, that is, a stress applied when the film exposing portion has been extended from 20 mm to 40 mm is divided by the cross sectional area of the film. The resulting value is made to be the tensile stress at 100% stretch.

In addition, by providing the protective members not only for the objective lens but also on the periphery thereof, the infliction of damage on the storage disk due to an accidental collision that would be able to occur while recording or playing back the storage disk can be reduced.

Additionally, by making the breaking strength of the protective member 0.43 kgf/mm² or larger, even in the event that an accidental collision between the protective member and the storage disk happens, the infliction of damage on the storage disk can be reduced, and furthermore, the protective member is made difficult to be abraded, whereby the continuity of the function of the protective member can be extended and the adhesion of fragments of the protective member that would otherwise result from abrasion thereof to the storage disk can also be reduced. Here, the breaking strength will be described using FIG. 20. The protective member is formed into a strip-like film sample 61 of the order of 5 mm×40 mm×60 μm, and the film so formed is made to be chucked with chucking jigs 62 of a tensile tester at both ends thereof so that a film exposing portion becomes approximately 20 mm. Then, the film is pulled at the ends thereof at steady speed by the tensile tester for measurement of stress applied then, and a stress applied when the film fails is divided by the cross sectional area of the film. The resulting value is made to be the breaking strength.

In addition, by using urethane acrylate for the protective member, a soft protective member whose ensile stress at 100% stretch 0.49 kgf/mm² or smaller can be prepared, whereby the infliction of damage on the storage disk due to an accidental collision that would be able to occur while recording or playing back the storage disk can be reduced. Here, the monomer is such as to be referred generally to as a reactive diluent and to make up part of the constituent elements of the protective member.

Additionally, the protective member is a polymerized mixture of a small amount of urethane acrylate and a large amount of monomer and can be prepared as the soft protective member having the tensile stress at 100% stretch of 0.49 kgf/mm² or smaller and the breaking strength of 0.43 kgf/mm² or larger by mixing 5 to 10 percent by weight of urethane acrylate and a monomer together and polymerizing the mixture, whereby the infliction of damage on the storage disk due to an accidental collision that would be able to occur while recording or playing back the storage disk can be reduced.

In addition, as the monomer, a monomer is used which contains 0.1 to 5 percent by weight of diacrylate monomer and 90 percent by weight of monomer which has a molecular weight of 150 to 500 and an annular construction, and the monomers are mixed and polymerized so as to prepare the protective member having the tensile stress at 100% stretch of 0.49 kgf/mm² or smaller and the breaking strength of 0.43 kgf/mm² or larger, whereby the infliction of damage on the storage disk can be reduced even in the event that an accidental collision occurs between the protective member and the storage disk, and furthermore, the protective member is made difficult to be abraded, whereby the continuity of the function of the protective member can be extended and the adhesion of fragments of the protective member that would otherwise result from abrasion thereof to the storage disk can also be reduced.

In addition, as the protective member, by mixing 30 percent by weight of urethane acrylate and 70 percent by weight of monomer whose molecular weight of 150 to 500 and which has an annular construction and polymerizing the mixture, a protective member having the tensile stress at 100% stretch of 0.21 kgf/mm² or smaller and the breaking strength of 0.71 kgf/mm² or larger, whereby the performance of reducing the infliction of damage on the storage disk and extending the continuity of the function of the protective member and the performance of reducing the adhesion of the constituent fragments of the protective member to the storage disk can be increased.

Additionally, as the protective member, by utilizing a polymer having at least hydroxyl group, the bonding force to the base material of the lens holder can be increased. In particular, while a liquid crystal polymer is known as having high dimension accuracy and mechanical strength and is hence often used as a material for the lens holder, the liquid crystal polymer is also known generally as having a small bonding force to a resin material. According to the embodiment of the invention, however, the bonding force to the liquid crystal polymer can be increased without largely reducing the performance as the protective member.

In addition, as the protective member, a polymer is used which has at least one of hydroxy-based acrylate monomer and hydroxy-based methacrylate monomer. The amount of hydroxyl group can easily be controlled by having the hydroxyl group in the monomer, whereby the bonding force can be controlled according to applications. Due to this, a polymer used for the protective member can also be used as a liquid crystal polymer adhesive such as one used, for example, to bond the lens holder and the objective lens together.

Additionally, as the protective member, by using a polymer in which urethane acrylate and various types of monomers are mixed together and polymerized or 20 percent by weight of urethane acrylate, 30 percent by weight of monomer whose molecular weight is 150 to 500 and which has an annular structure and 50 percent by weight of at least one of hydroxy-based acrylate monomer and hydroxy-based methacrylate monomer, a protective member having the tensile stress at 100% stretch of 0.11 kgf/mm² or smaller and the breaking strength of 1.72 kgf/mm² or larger, whereby the performance of reducing the infliction of damage on the storage disk and extending the continuity of the function of the protective member and the performance of reducing the adhesion of the constituent fragments of the protective member to the storage disk can be increased. Moreover, the protective member so prepared can be imparted a strong bonding force to the lens holder, whereby the separation or fall of the protective member from the lens holder can be reduced which would otherwise occur by virtue of an impact generated by a collision of the protective member with the storage disk.

Additionally, by using a material containing a liquid crystal polymer as the base material of the lens holder, a lens holder results which has a strong bonding force to the protective member, a high dimension accuracy and a high mechanical strength.

In addition, by dropping a mixture of at least urethane acrylate and a monomer to the periphery of the objective lens and setting the mixture so dropped so as to have the tensile stress at 100% stretch of 0.49 kgf/mm² or smaller, the protective member can be produced by a simple production method, thereby making it possible to increase largely the productivity.

Additionally, by devising the shape of a protective member setting portion of the lens holder, the shape of the protective member can freely be altered, whereby the protective member can be modified in shape in any way according to applications.

### Examples

Hereinafter, examples of the invention will be described. When weighing constituent materials, an error of the order of +/−5% poses no problem in terms of performance, and therefore, an error something like that is to be permitted. In addition, there is no specific limitation on emitting machines and lamps which are used for ultraviolet ray emission.

As to test sample preparing methods, test samples were prepared as follows and used for the relevant tests. A test piece sample for the collision test was prepared by dropping a resin, which has not yet been polymerized, on the test piece 124 using a dispenser for polymerization thereon, and a sample for the dynamic viscous elasticity and tensile tests was prepared by applying a material to a glass plate to which a releasant is applied or a fluoroplatic film having good releasability using a doctor blade technique for polymerization thereon and cutting the glass plate or film into a predetermined size.

### Example 3

While urethane acrylate is expressed by a general structural formula as CH2═CHCOO—R′—OCNH—(R—NHCOO-(polyol)-OOCNH)ₙ—R—NHCOO—R′—-OCOCH═CH2, since a detailed structure is unknown, examples of commercially available urethane acrylates are shown in (Table 5).

10 g of UN6012N among the urethane acrylates shown in (Table 5), 10 g of each of phenol EO modified acrylate and isobornyl acrylate among the monomers shown in (Table 6), 0.4 g of 2-benzyl-2-dimethylamino-1-(4-moliphelinophenyl)-butanone-1 among the photopolymerization initiators shown in (Table 8) and 0.3 g of BYK344 among the additives shown in (Table 9) were weighed respectively and mixed well together while being warmed in a water bath, and the mixture was irradiated with ultraviolet ray by 500 mJ/cm² so as to be polymerized. The resulting protective member was made to be Example 3.

### Example 4

30 g of UN6012NB among the urethane acrylates shown in (Table 5), 35 g of each of phenol EO modified acrylate and isobornyl acrylate among the monomers shown in (Table 6), 0.4 g of 2-benzyl-2-dimethylamino-1-(4-moliphelinophenyl)-butanone-1 among the photopolymerization initiators shown in (Table 8) and 0.3 g of BYK344 among the additives shown in (Table 9) were weighed respectively and mixed well together while being warmed in a water bath, and the mixture was irradiated with ultraviolet ray by 500 mJ/cm² so as to be polymerized. The resulting protective member was made to be Example 4.

### Example 5

20 g of UN6012NB among the urethane acrylates shown in (Table 5), 30 g of isobornyl acrylate among the monomers shown in (Table 6), 50 g of hydroxy-based acrylate monomer in (Table 7), 0.4 g of 2-benzyl-2-dimethylamino-1-(4-moliphelinophenyl)-butanone-1 among the photopolymerization initiators shown in (Table 8) and 0.3 g of BYK344 among the additives shown in (Table 9) were weighed respectively and mixed well together while being warmed in a water bath, and the mixture was irradiated with ultraviolet ray by 500 mJ/cm² so as to be polymerized. The resulting protective member was made to be Example 5.

### Comparison Example 4

TB3075 by 3-Bond was irradiated with ultraviolet ray by 500 mJ/cm² so as to be polymerized, and the resulting protective member was made to be Comparison Example 4.

### Comparison Example 5

KJR9022 by Shinetsu Chemicals was well mixed under a formula recommended by the manufacturer, and the mixture was polymerized 240 minutes at 150° C., and the resulting protective member was made to be Comparison Example 5.

### Comparison Example 6

10 g of UN6012N among the urethane acrylates shown in (Table 5), 90 g of phenol EO modified acrylate among the monomers shown in (Table 6), 0.4 g of 2-benzyl-2-dimethylamino-1-(4-moliphelinophenyl)-butanone-1 among the photopolymerization initiators shown in (Table 8) and 0.3 g of BYK344 among the additives shown in (Table 9) were weighed respectively and mixed well together while being warmed in a water bath, and the mixture was irradiated with ultraviolet ray by 500 mJ/cm² so as to be polymerized. The resulting protective member was made to be Comparison Example 6.

### Comparison Example 7

30 g of UN6012N among the urethane acrylates shown in (Table 5), 70 g of phenol EO modified acrylate among the monomers shown in (Table 6), 0.4 g of 2-benzyl-2-dimethylamino-1-(4-moliphelinophenyl)-butanone-1 among the photopolymerization initiators shown in (Table 8) and 0.3 g of BYK344 among the additives shown in (Table 9) were weighed respectively and mixed well together while being warmed in a water bath, and the mixture was irradiated with ultraviolet ray by 500 mJ/cm² so as to be polymerized. The resulting protective member was made to be Comparison Example 7.

### Comparison Example 8

KR5235 by Shinetsu Chemicals was polymerized 60 minutes at 200° C., and the resulting protective member was made to be Comparison Example 8.

The disk unit according to the embodiment of the invention can be used for an impact absorbing material, a damage infliction preventive material and the like. In particular, in storage disks such as optical disks, hard disks and MO's which are liable to be damaged easily, the infliction of damage on the storage disk due to a collision with the data recording/playing back unit can be reduced largely. The protective member of the invention is preferably applied, in particular, to the Blu-ray disk whose working distance is very small among those storage disks.

This application based upon and claims the benefit of priority of Japanese Patent Application No 2005-224885 filed on May 8, 2003, and Japanese Patent Application of the No 2005-350371 filed on May 12, 2005, the contents of which are incorporated herein by reference in its entirety.

What is claimed is:

1. A disk unit having:
an objective lens for focusing light on the storage disk;
a holder for holding the objective member;
a protector for protecting the storage disk from a damage; and
a motor for rotationally driving the storage disk, wherein
an arrangement of the protector is substantially parallel to a hypothetical straight line between a rotational center of the motor and an optical axis of the objective lens.

2. The disk unit as set forth in claim 1, wherein the protector is provided on both sides of the objective member.

3. The disk unit as set forth in claim 1, wherein a cross section of the protector taken widthwise has a shape which protrudes towards the storage disk.

4. The disk unit as set forth in claim 3, wherein a cross section of the protector taken widthwise has a shape which contains partially an arc.

5. The disk unit as set forth in claim 1, wherein the protector is disposed at a position which lies on the holder except for an area defined as lying further upstream in a rotational direction and radially closer to a rotational center of the storage disk than the objective lens.

6. The disk unit as set forth in claim 1, wherein the protector is made up of a protective member which is formed on a base material which makes up the holder.

7. The disk unit as set forth in claim 6, wherein a protective member forming portion where the protective member is formed is provided by altering a height of the base material which makes up the holder.

8. The disk unit as set forth in claim 7, wherein the protective member forming portion has a straight or curved groove which passes through substantially a center of the protective member forming portion when viewed from a storage disk side.

9. The disk unit as set forth in claim 1, wherein two pairs of the protector is provided on both sides of the objective lens.

10. A disk unit for recording or reproducing an information on a storage disk having:
a light source for emitting short-wavelength light;
an objective lens for focusing light from the light source on the storage disk;
a light receiving unit for receiving light from the light source;
a holder for holding the objective member;
a protector for protecting the storage disk from a damage;
a base for holding the holder in such a manner as to move freely in a radial direction of a storage disk; and
a motor provided on the base for rotationally driving the storage disk, wherein
an arrangement of the protector is substantially parallel to a hypothetical straight line between a rotational center of the motor and an optical axis of the objective lens.

11. The disk unit as set forth in claim 6, wherein the protective member is a protective member for protecting at least the storage disk and has a tensile stress at 100% stretch of 0.49 kgf/mm² or smaller.

12. The disk unit as set forth in claim 6, wherein the protective member has a breaking strength of 0.43 kgf/mm² or larger.

13. The disk unit as set forth in claim 6, wherein the protective member results from a polymerization of at least urethane acrylate and a monomer.

14. The disk unit as set forth in claim 13, wherein the protective member results from a polymerization of 5 to 10 percent by weight of the urethane acrylate and the monomer.

15. The disk unit as set forth in claim 13, wherein the monomer contains 0.1 to 5 percent by weight of diacrylate monomer and 90 percent by weight of monomer which has a molecular weight of 150 to 500 and an annular construction.

16. The disk unit as set forth in claim 14, wherein the monomer contains 0.1 to 5 percent by weight of diacrylate monomer and 90 percent by weight of monomer which has a molecular weight of 150 to 500 and an annular construction.

17. The disk unit as set forth in claim 13, wherein the protective member is a polymer having at least a hydroxyl group.

18. The disk unit as set forth in claim 17, wherein the protective member is a polymer having at least one of a hydroxy-based acrylate monomer and a hydroxy-based methacrylate monomer.

19. The disk unit as set forth in claim 17, wherein the lens holder has a base material which holds the protective member, and the base material contains a liquid crystal polymer.

20. A disk unit for recording or reproducing an information on a storage disk having:
an objective lens for focusing light on the storage disk;
a holder for holding the objective lens; and
a protector for preventing the storage disk from contacting with the objective lens or the holder, wherein
the protector is so arranged that the width of the protector in a rotational direction of the storage disk is minimized.
